(19) United States
(12) Patent Application Publication
(10) Pub. No.: US 2002/0017742 A1
(43) Pub. Date: Feb. 14, 2002

(54) Method and apparatus for manufacturing molded products

(76) Inventors: Masanori Kikuchi, Iwatsuki-shi (JP); Kazutoshi Nagahori, Iwatsuki-shi (JP)

Correspondence Address: McGLEW AND TUTTLE, P.C., SCARBOROUGH STATION, SCARBOROUGH, NY, 10510-0827, US

(21) Appl. No.: 09/920,077

(22) Filed: Aug. 1, 2001

(30) Foreign Application Priority Data
Aug. 3, 2000 (JP) 2000-235359

(51) Int. Cl. B29C 31/04

(52) U.S. Cl. 264/333; 425/261

(57) ABSTRACT

The invention encompases method and apparatus for manufacturing molded products from a material which comprises scraps of waste plastics products. The apparatus comprises a supply station 12 for supplying the material into a female mold 11, a heating station 13, a cooling station 14 and an intermittent transfer device 15 for intermittently transferring the female mold to the supply station, the heating station and the cooling station in a sequestial order. The heating station comprises a compression molding press having a heater-equipped holder 17 for vertically movably holding and heating a male mold 16 to be releasably fitted in the female mold and a heater-equipped lower support 18 for supporting and heating the female mold transferred thereto by the intermittent transfer device. The cooling station comprises a cooling press having an upper cold mold 19 to be releasably fitted in the female mold and a cooling device 20 for cooling the female mold, together with the upper cold mold fitted therein.

### BACKGROUND OF THE INVENTION

1. Field of the Invention

The present invention relates generally to a method and apparatus for manufacturing molded products, and more particularly to a method and apparatus for manufacturing molded products from a material which comprises scraps of waste plastics products.

2. Description of the Prior Art

In the field of the invention, a method of manufacturing a product of resin concrete is known which comprises steps of: heating a female mold and a male mold in a heating device; feeding a mixture, which contains an aggregate and a thermosetting resin for binding the aggregate, into the female mold; fitting the male mold in the female mold and pressurizing the mixture in the female mold by means of a pressurizing device; heating said molds with a hot press while keeping a pressurizing condition by means of a pressurization holding means; thereafter, removing said molds from said hot press and cooling said molds; then, releasing said pressurization holding means, separating said molds from each other and removing the molded product from the female mold; and repeating the foregoing steps (cf.WO 95/13178 ).

In the known method and an apparatus for carrying out the method, it is necessary not only to provide the female mold with said pressurization holding means, but also to provide the apparatus with an apparatus for operating said pressurization holding means. Therefore, the production cost as well as the running cost of the apparatus will inevitably become high. Moreover, in the known method, it is necessary not only to heat the male mold as well as the male mold at each time the product is manufactured, but also to cool both of the molds before the product is removed from the female mold. This is detrimental to thermal efficiency in the molding processes.

### SUMMARY OF THE INVENTION

The present invention is intended to eliminate the disadvantages or drawbacks indicated with the prior art as described above and to provide an improved method and apparatus for manufacturing molded products from a material, which comprises scraps of waste plastics products, by the application of heat and pressure, wherein heating processes and cooling processes in the compression molding of the moldable material are improved so that energy-saving and shortening of the molding cycle can be effectively attained.

It is, therefore, one object of the present invention to provide a method and apparatus of the kind described above which do not require the provision of the aforementioned pressurization holding means and apparatus for operating it, thereby making it possible to reduce the production cost of the apparatus and to simplify the compression molding processes.

It is another object of the invention to provide the method and apparatus of the kind stated above which do not require to heat the upper and lower molds at each time when the product is manufactured and to cool both of the molds before the product is removed from the lower mold, thereby making it possible to enhance the thermal efficiency in the molding processes.

It is a further object of the present invention to provide the method and apparaus of the kind stated above which is capable of effectively attaining energy-saving and shortening of the molding cycle.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which the method and apparatus of the envention is illustrated.

### BRIEF DESCRIPTION OF DRAWINGS

FIG. 1 is a schematic plan view of one embodiment of the present invention;

FIG. 2 is a schematic vertical cross-sctional view of the heating station shown in FIG. 1;

FIG. 3 is a schematic vertical cross-sectional view of the cooling station shown in FIG. 1;

FIG. 4 is a schematic front view of the material supply station shown in FIG. 1;

FIG. 5 shows a variant of the heating station shown in FIG. 2;

FIG. 6 is a vertical cross-sectional view of a portion of FIG. 5 in an enlarged scale;

FIG. 7 shows a varient of the embodiment shown in FIG. 1;

FIG. 8 is a schematic front view of the material supply station and preheater shown in FIG. 7;

FIG. 9 shows a varient of the cooling station in FIG. 3;

FIG. 10 illustrates one example of a resin concrete block manufactured in accordance with the present invention; and

FIG. 11 illustrates another example of a resin concrete block manufactured in accordance with the present invention.

### DETAILED DESCRIPTION

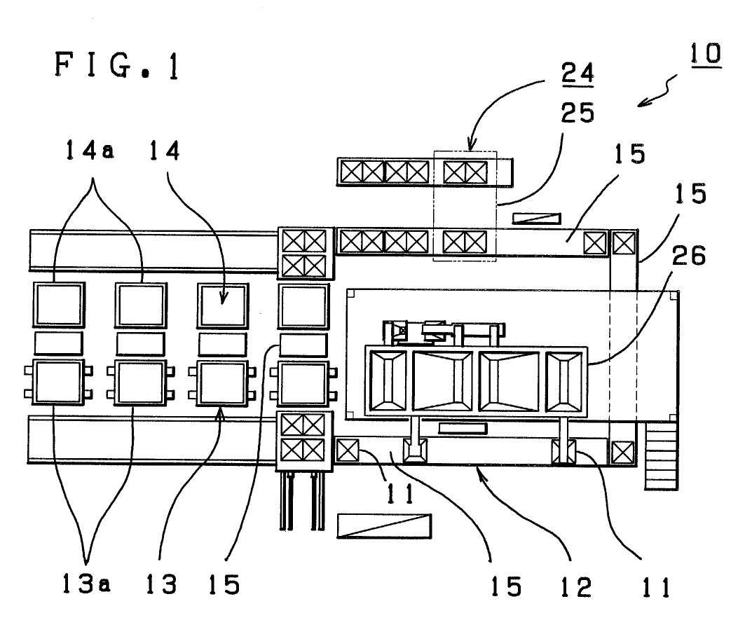

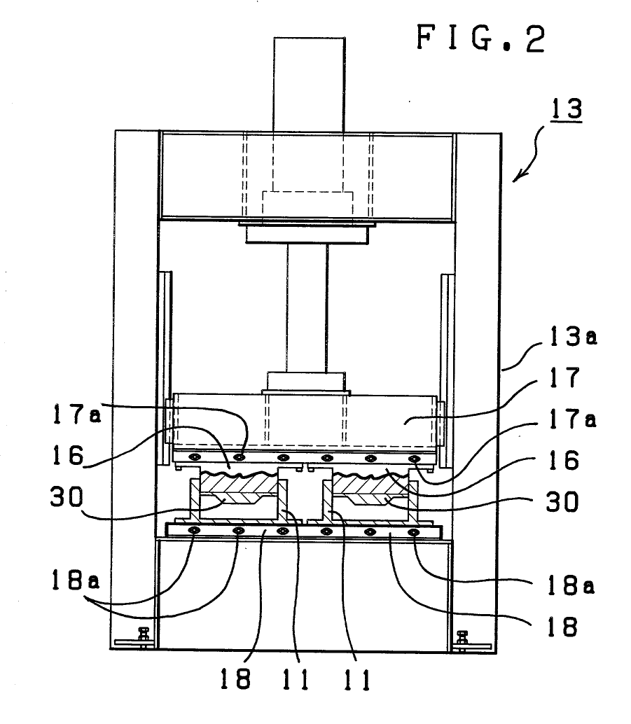

Referring now to the drawings in FIGS. 1 to 4, there is shown one embodiment of the present invention. In the drawing in FIG. 1, reference numeral 10 generally designates an apparatus for manufacturing molded products from a material which comprises waste scraps of plastics product according to the present invention.

The apparatus 10 comprises a supply station 12 for supplying said material into a female mold 11 as a lower compression mold, a heating station 13 for heating the female mold 11 and a male mold 16 as an upper compression mold releasably fitted therein, a cooling station 14 for cooling said female mold and an intermittent transfer device 15 for intermittently transferring said femal mold to said supply station 12, said heating station 13 and said cooling station 14 in a sequential order. The heating station 13 comprises a compression molding press 13a having a holder 17 in which heaters 17a are mounted for vertically movably holding and heating said male mold 16 and a lower support means 8 in which heaters 18a are mounted for supporting and heating said female mold 11 transferred thereto by means of said intermittent transfer device 15. The cooling station 14 comprises a cooling press 14a having a vertically movable upper cold mold 19 to be releasably fitted in said female mold 11 and a cooling means 20 for cooling said female mold, together with said upper cold mold 19 fitted therein. The cooling means 20 comprises a shower head 20a which is located in the vicinity of said upper cold mold 19 and a water jacket 20b for receiving cooling water sprayed over said female mold 11.

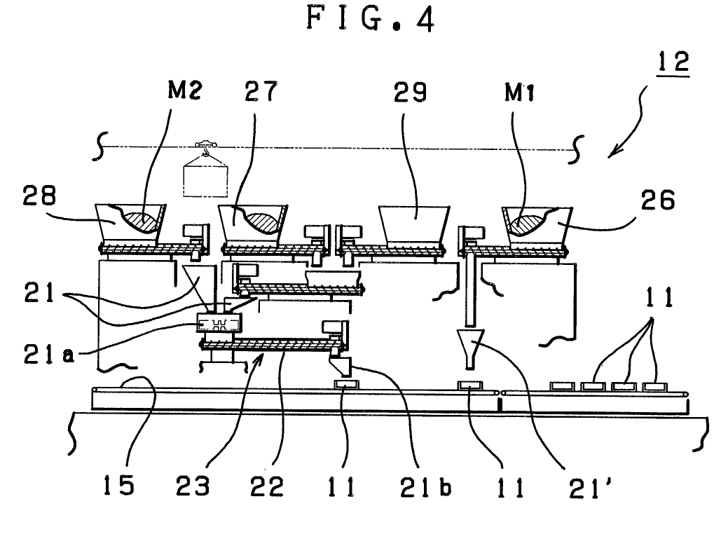

The material supply staition 12 is provided with a feeder 23 which comprises measuring hoppers 21 for measuring and feeding said material into said female mold 11 by way of a mixer 21a, an extruder 22 and a final measuring hopper 21b. Also, in the apparatus a molding-removing station 24 is provided downstream of said cooling station 14 and in front of said material supply station 12. The removing station 24 comprises a molding-removing device 25 for removing the molding P made in said female mold 11 therefrom. As shown in FIG. 4, the material supply station 12 is further provided with a first feed hopper 26, a second feed hopper 27, a third feed hopper 28, a fourth feed hopper 29 and a measuring hopper 21′ connected with the first feed hopper 26 through a conveyer. Indicated by reference numeral 30 is an intermediate mold member which is placed on the material fed into the female mold 11 to compress said material in cooperation with said male mold 16.

The material and/or molds used for making a shaped product in accordance with the present invention vary depending upon a kind and/or shape and/or size of the product to be made. Thus, as to the material, it can be selected, as occasion demands, from among such materials as follows: a material consisting of 100% scraps of waste plastics (thermoplastic sysnthetic resin) products: a material comprising scraps of waste plastics products and used paper chips or burr and the like produced in a variety of molding processes, such as blow molding, injection molding, extrusion molding, etc.; a mixture comprising scraps of waste plastics products and an aggregate which contains sands, small pebbles, crushed cement concrete, etc.; a mixture comprising said mixture and used tire chips; and a mixture comprising said mixture and used paper chips.

In this connection, it is to be noted that an ornamental material such as leaf, wood chips, mineral particulate, colored plastic chips or the like may be used as an additional material to form a surface layer of an ornamental design integrally with a product to be manufactured. A transparent film or semi-transparent film on which an ornamental design is printed may also be used to cover the product made.

In the illustrated embodiment, the aforementioned molds 11, 16, 30 are designed for use in manufacturing a resin concrete block P which is used for covering a ditch. To form such a block P, a mixture comprising scraps of waste plastics products, an aggregate M2 which contains sands, small pebbles, crushed cement concrete, etc. or a mixture comprising said mixture and used tire chips M1 may be made. Next, therefore, description will now be directed to how to manufacture the resin concrete block P with the use of the aforementioned apparatus as one embodiment of the present invention.

First of all, the used tire chips M1 which form an upper layer of the resin concrete block P (FIG. 10) are supplied from the first feed hopper 26 into the female mold 11 by way of the measuring hopper 21′. Thereafter, the scraps of waste plastics products and the aggregate M2 are respectively fed from the second feed hopper 27 and the third feed hopper 28 into the measuring hoppers 21 so as to be measured therein. Then, the scraps and the aggregate are fed into the mixer 21a and mixed with each other. Then, a mixture of the scraps and aggregate is fed into the extruder 22 to be heated and kneaded therein so as to become semifluidic. Thereafter, the mixture is measured in the final measuring hopper 21b and fed therefrom into the female mold 11 in such a manner that it is superimposed on the layer of the tire chips M1. When the scraps and aggregate are fed into the mixer 21a, the burr and the like may additionally be supplied thereinto from the fourth hopper 29 so as to be mixed with them.

After the mixture has been supplied into the female mold 11 in the manner mentioned above, the intermediate mold member 30 in the form of a male mold is placed on the mixture. Then, the female mold 11 is moved into the compression molding press 13a of heating station 13 by means of the intermittent transfer device 15 so as to be heated, together with the male mold 16 fitted in said female mold 11 in said molding press. More specifically, the male mold 16 is heated by the heater-equipped holder 17 and the female mold 11 heated by the heater-equipped lower support means 18. Thereafter, the heated male mold 16 as an upper compression mold that is located above at rest is lowered and fitted in the heated female mold 11 to hot-press the material therein, through the medium of said intermediate mold member 30, to form said resin concrete block P.

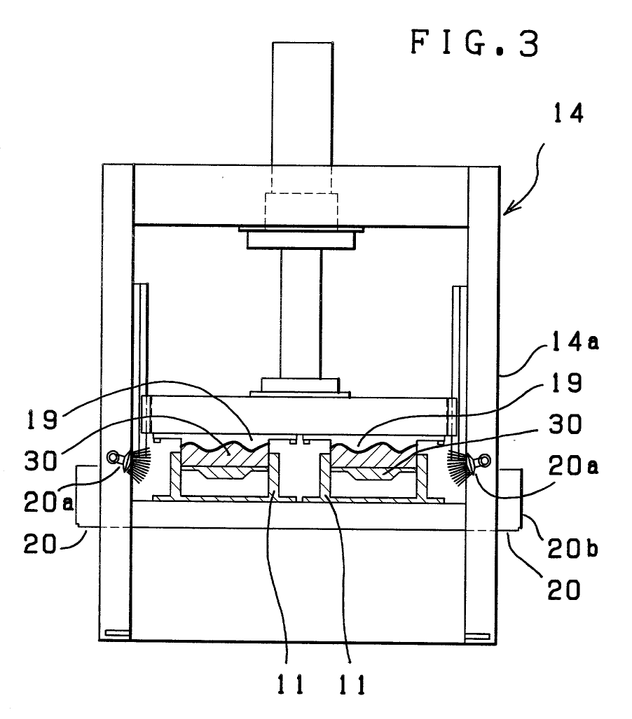

After the resin concrete block P has been made in the female mold 11 by the compression molding, the female mold is moved with the intermediate mold member 30 from said press 13a to the cooling press 14a of cooling station 14 by means of the intermittent transfer means 15 to cool the block P in said female mold. More specifically, after the male mold 16 has been released from the female mold 11, the latter is removed from said lower support means 18 and transferred therefrom to the cooling press 14a, together with the intermediate mold member 30 by means of said transfer device 15. Then, the upper cold mold 19 is fitted in the female mold 11 at the cooling press 14a. Thereafter, cooling water is discharged toward said female mold from the shower head 20a of said cooling device 20, as shown in FIG. 3, thereby cooling said resin concrete block P. The cooling water which has been used in this way is received by the water jacket 20b and circulated.

After cooling said block, the upper cold mold 19 is moved upwardly and separated from the female mold 11 having the molded block P therein. Then, the female mold 11 from which the male mold 16 has been separated is transferred from said cooling station to the molding-removing station 24 and the block P is removed from said female mold, together with said intermediate mold member 30 by means of the removing device 25 of said molding-removing station. Also, the block P is separated from said mold member 30. Thereafter, the emptied female mold 11 is returned to the material supply station 12 by means of said intermittent transfer device 15 so that the aforementioned molding steps can be repeated.

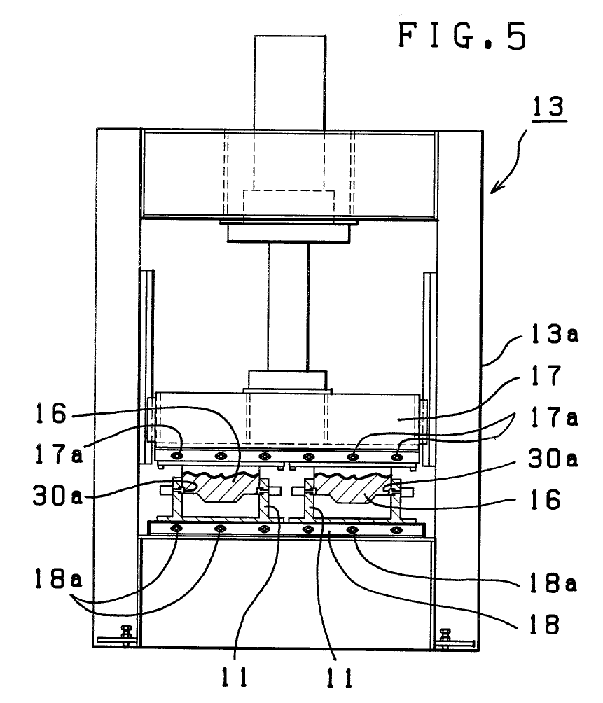

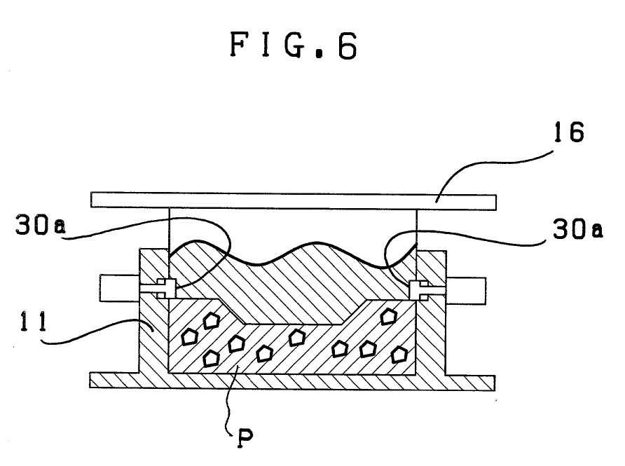

It is to be noted that the provision of the intermediate mold member 30 is not indispensable. As shown in FIGS. 5 and 6, instead of said mold member 30, horizontally retractable stoppers 30a for preventing the molding P from being stuck to and raised with the male mold 16 may be provided in side walls of said female mold 11.

According to the present invention, it is possible to provide various kinds of molded products other than the aforementioned resin concrete product P by selectively using such materials as aforementined. For example, in case where a molded product is desired to be manufactured from scraps of waste plastics products, one has only to carry out the same steps as aforementioned with the exception of stopping supplying other substances, such as tire chips M1, aggregate M2, etc. Also, it is possible to manufacture a water permeable product, which has numerous gaps allowing water to pass therethrough, from a material comprising a large amout of aggregate and a small amount of scraps of waste plastics products for binding the aggregate as a binder.

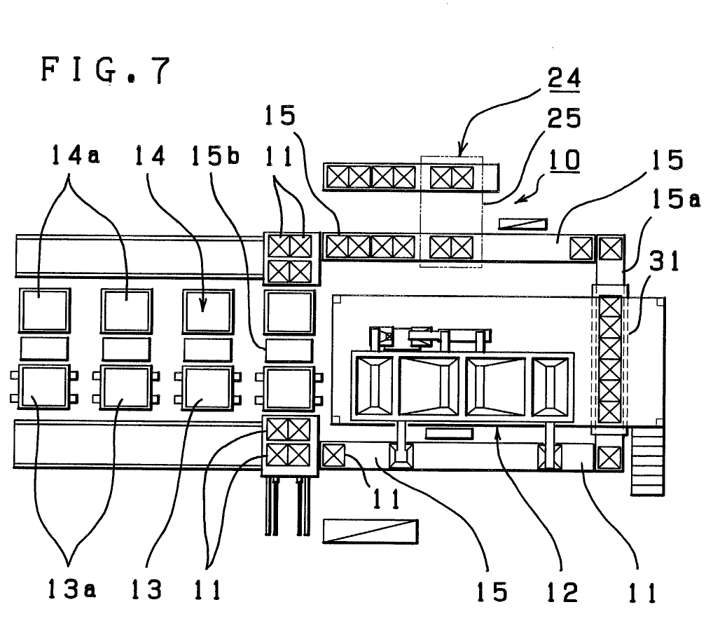

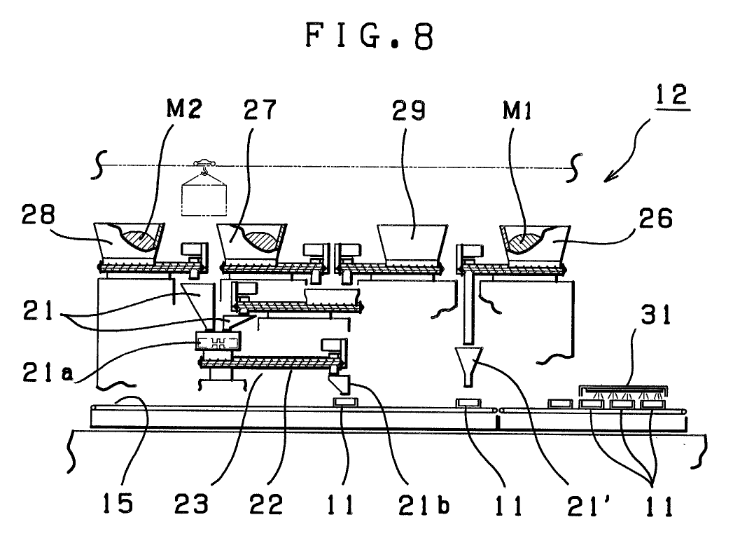

FIGS. 7 and 8 show a variant of the embodiment shown in FIGS. 1 and 4. In the drawings in FIGS. 7 and 8, the same portions or parts as those in FIGS. 1 and 4 are designated by like numerals. The variant differs from the embodiment in that the former is provided with a preheater 31 for preheating said emptied female mold 11 that is provided between the molding-removing station 24 and the material supply station 12. The preheater 31 is a far-infrared heating device. However, it may be a hot-blast stone.

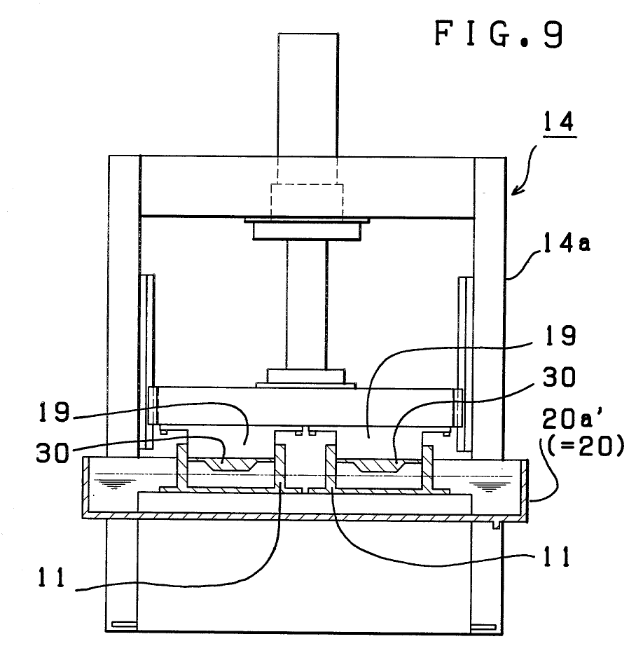

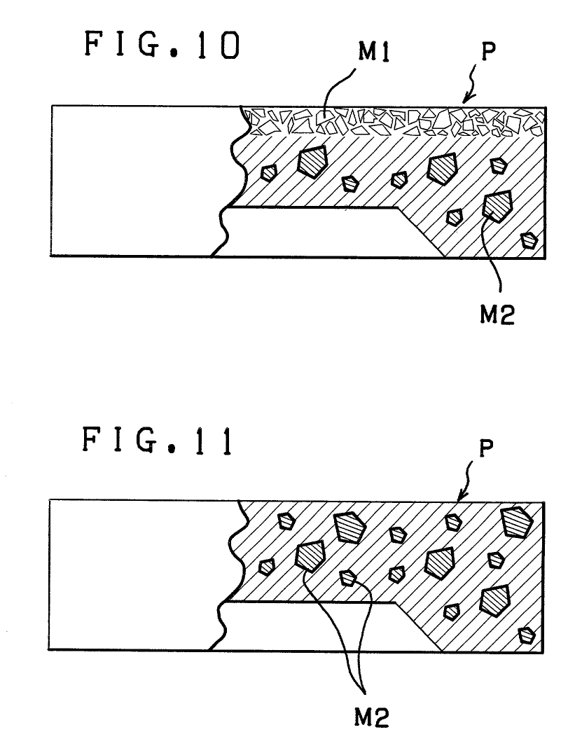

FIG. 9 shows a variant of the cooling press 14a of cooling station 14. In this variant, the cooling device 20 comprises a cooling water reservoir 20a′. As shown in FIG. 9, the female mold 11 is cooled in the state in which it is partly immersed in the cooling water.

It is to be understood that the present invention may be embodied in other specific form without departing from the spirit or essential characteristics of the present invention. The preferred embodiment and varients thereof are therefore to be considered illustrative and not restrictive.

What is claimed is:

1. Method for manufacturing molded products from a material which comprises scraps of waste plastics products, said method comprising the steps of: feeding said material into a female mold at a material supply station; transferring said female mold fed with said material to a heating station and heating said female mold and a male mold releasably fitted therein at the heating station; transferring said female mold with a molding made therein to a cooling station to cool said molding; then, removing said molding from said female mold at a molding-removing station located downstream of said cooling station; thereafter, returning the emptied female mold to said material supply station; and repeating the foregong steps.

2. The method as claimed in claim 1, wherein said emptied female mold is preheated between said molding-removing station and said material supply station.

3. The method as claimed in claim 1, wherein said material is fed into said female mold while being kneaded by means of an extruder.

4. The method as claimed in claim 1, wherein said material comprises a mixture which contains an aggregate and scraps of waste plastics products for binding the aggregate and wherein said material comprising said mixture is fed into said female mold under a semifluidic condition while being kneaded and heated by means of an extruder.

5. The method as claimed in claim 4, whereby a product of resin concrete is manufactured.

6. Apparatus for manufacturing molded products from a material which comprises scraps of waste plastics products, said apparatus comprising a supply station for supplying said material into a female mold, a heating station, a cooling station and an intermittent transfer device for intermittently transferring said femal mold to said supply station, said heating station and said cooling station in a sequential order, said heating station comprising a compression molding press having a heater-equipped holder means for vertically movably holding and heating a male mold to be releasably fitted in said female mold and a heater-equipped lower support means for supporting and heating said female mold transferred thereto by means of said transfer device, said cooling station comprising a cooling press having an upper cold mold to be releasably fitted in said female mold and a cooling means for cooling said female mold, together with said upper cold mold fitted therein.

7. The apparatus as claimed in claim 6, wherein said cooling means is provided with a shower head in the vicinity of said upper cold mold.

8. The apparatus as claimed in claim 6, wherein said cooling means is provided with a cooling water reservoir.

9. The apparatus as claimed in claim 6, wherein said supply staition is provided with a feeder which comprises a hopper for feeding said material into said female mold and an extruder for extruding said material into said hopper.

10. The apparatus as claimed in claim 6, wherein a molding-removing station is provided downstream of said cooling station and wherein a preheating device for preheating the empty female mold from which the molding made therein has been removed is provided between said molding-removing station and said supply station.

11. The apparatus as claimed in claim 10, wherein said preheating device is one of a far-infrared heating device and a hot-blast stove.
